(19) United States
(12) Patent Application Publication
(10) Pub. No.: US 2025/0351997 A1
(43) Pub. Date: Nov. 20, 2025

(54) GRIDDLE PLATEN HEIGHT ADJUSTMENT METHOD AND SYSTEM

(71) Applicant: AccuTemp Products, Inc., Fort Wayne, IN (US)

(72) Inventors: Craig Seitz, New Haven, IN (US); Gary Seitz, New Haven, IN (US); Raymond Rudy, New Haven, IN (US)

(21) Appl. No.: 18/666,996

(22) Filed: May 17, 2024

(51) Int. Cl. A47J 37/06

(52) U.S. Cl. CPC A47J 37/0611; A47J 2037/0617

(57) ABSTRACT

A height adjustment mechanism is provided for setting a gap between upper and lower platens of a griddle, comprising: a height plate coupled to an armature of the upper platen, a stud and a lower end to engage a stop of the lower platen when the upper platen is in a lowered position; an adjustment plate coupled to the armature for rotation relative to the height plate and including a cam slot to receive the stud; a coupler; and a clamp that is movable between an unlocked position wherein the rotation of the adjustment plate causes the stud to move within the cam slot to adjust the height plate to a position corresponding to a desired gap when the lower end engages the stop, and a locked position wherein the clamp prevents rotation of the adjustment plate, locking the height plate in position and setting the desired gap.

### TECHNICAL FIELD

The present disclosure is directed to a griddle and, in particular, to a griddle with an upper platen having a height adjustment mechanism for setting spacing of the upper platen above the lower platen in a cooking position of the upper platen.

### BACKGROUND

Griddles can feature upper platen assemblies suited for a variety of purposes, including searing and/or cooking from above with a heat source (see, e.g., U.S. patent application Ser. No. 17/837,541, the entire disclosure of which is hereby explicitly incorporated herein by reference). An important step in preparing a griddle upper platen for cooking is setting an appropriate gap between the lower surface of the upper platen and the upper surface of the griddle. This gap determines the final thickness of food products cooked using the griddle. The gap also contributes to ensuring a uniform temperature across the food product. In many applications, the gap requires adjustment to accommodate different food products, which may be a time-consuming task. Thus, a height adjustor for quickly and easily setting the spacing between the upper platen and the griddle is desirable to facilitate setting the thicknesses of various cooked food products.

### SUMMARY

According to one embodiment, the present disclosure provides a height adjustment mechanism for setting a cooking gap between an upper platen assembly and a lower platen of a griddle assembly when the upper platen assembly is in a lowered position, comprising: a height set plate configured to be coupled to an armature of the upper platen assembly for vertical movement, the height set plate including a slot, a stud and a lower end configured to engage a stop surface of the lower platen when the upper platen assembly is in the lowered position; an adjustment lever plate coupled to the armature for rotatable movement relative to the height set plate, the adjustment lever plate including a cam body having a cam slot configured to receive the stud of the height set plate, and an opening extending through the cam body; and a locking mechanism comprising: a coupler extending through the opening of the cam body, through the slot of the height set plate, and into an opening of the armature, and a clamp that is movable between an unlocked position wherein the cam body may be rotated about the coupler to cause the stud to move within the cam slot, thereby adjusting a vertical position of the height set plate relative to armature to a vertical position corresponding to a desired cooking gap when the lower end of the height set plate engages the stop surface of the lower platen when the upper platen assembly is in the lowered position, and a locked position wherein the clamp prevents rotation of the cam body and retains the stud in position within the cam slot, thereby locking the height set plate in position and setting the desired cooking gap. In one aspect of this embodiment, the coupler is a fastener that couples the adjustment lever plate and the height set plate to the armature and permits the adjustment of the vertical position of the height set plate and rotational movement of the adjustment lever plate relative to the armature. In a variant of this aspect, the clamp includes a rod that threads into the stud of the height set plate. In a further variant, the clamp includes a shoulder that engages the adjustment lever plate when the rod is threaded into the stud such that the clamp is in the locked position to compress the height set plate between the adjustment lever plate and the armature to prevent vertical movement of the height set plate. In another aspect, the coupler extends from the clamp. In a variant of this aspect, the coupler includes a rod that threads into the opening of the armature. In a further variant, the clamp includes a shoulder that engages the adjustment lever plate when the rod is threaded into the opening of the armature such that the clamp is in the locked position to compress the height set plate between the adjustment lever plate and the armature to prevent vertical movement of the height set plate. In yet another variant, the coupler includes a rod that extends through the opening in the armature, a retainer clip that couples to the rod, and a spring positioned over the rod between the armature and the retainer clip. In a still further variant, the spring is compressed between the armature and the retainer clip to apply a biasing force to the clamp to bias the clamp toward the adjustment lever plate. In a further variant, the adjustment lever plate includes a plurality of position openings and the clamp includes a locking arm with a pin extending therefrom, wherein the biasing force of the spring biases the pin into one of the plurality of position openings, thereby locking the clamp into the locked position. In yet a further variant, the clamp is moveable away from the adjustment lever plate against the biasing force of the spring to withdraw the pin from the one of the plurality of position openings thereby placing the clamp in the unlocked position, and rotatable about a longitudinal axis of the rod to align the pin with another of the position openings. In another variant, when the clamp is rotated to align the pin with the other of the position openings, the clamp may be released to permit the biasing force of the spring to bias the pin into the other of the plurality of position openings, thereby locking the clamp in the locked position. In another variant, the plurality of position openings is arranged to form a curved sequence of position openings, each position opening corresponding to a different cooking gap. In another variant of this aspect, the clamp includes a handle for moving the clamp away from the adjustment lever plate and rotating the clamp relative to the adjustment lever plate. In yet another aspect of this embodiment, the height set plate is guided through vertical movement relative to the armature by a pair of guide arms extending from the armature. In another aspect, the slot of the height set plate extends along a longitudinal axis of the height set plate. In yet another aspect, the adjustment lever plate includes a lever extending from the cam body for rotating the adjustment lever plate relative to the height adjustment plate. In another aspect, the cam slot of the adjustment lever plate is curved between a first end and a second end. In yet another aspect of this embodiment, the cam body of the adjustment lever plate includes a plurality of position markers positioned along the cam slot, the position markers corresponding to a plurality of cooking gaps when the upper platen assembly is in the lowered position.

According to another embodiment of the present disclosure, an upper platen assembly for a griddle is provided, comprising: an upper platen having a lower surface; an armature extending from the upper platen; a handle for moving the upper platen assembly between a raised position and a lowered position wherein the lower surface of the upper platen is spaced apart from an upper surface of a lower platen of the griddle by a cooking gap; and a height adjustment mechanism coupled to the armature, the height adjustment mechanism comprising: a height set plate configured to the armature for vertical movement relative to the armature, the height set plate including a slot, a stud and a lower end configured to engage a stop surface of the lower platen when the upper platen assembly is in the lowered position, thereby setting the cooking gap; an adjustment lever plate coupled to the armature for rotatable movement relative to the height set plate, the adjustment lever plate including a cam body having a cam slot configured to receive the stud of the height set plate, and an opening extending through the cam body; and a locking mechanism including a coupler and a clamp; wherein the coupler extends through the opening of the cam body, through the slot of the height set plate, and into an opening of the armature; and wherein the clamp is movable between an unlocked position wherein the cam body may be rotated about the coupler to cause the stud to move within the cam slot, thereby adjusting a vertical position of the height set plate relative to armature to a vertical position corresponding to a desired cooking gap when the lower end of the height set plate engages the stop surface of the lower platen when the upper platen assembly is in the lowered position, and a locked position wherein the clamp prevents rotation of the cam body and retains the stud in position within the cam slot, thereby locking the height set plate in position and setting the desired cooking gap. In one aspect of this embodiment, the coupler is a fastener that couples the adjustment lever plate and the height set plate to the armature and permits the adjustment of the vertical position of the height set plate and rotational movement of the adjustment lever plate relative to the armature. In a variant of this aspect, the clamp includes a rod that threads into the stud of the height set plate. In a further variant, the clamp includes a shoulder that engages the adjustment lever plate when the rod is threaded into the stud such that the clamp is in the locked position to compress the height set plate between the adjustment lever plate and the armature to prevent vertical movement of the height set plate. In another aspect of this embodiment, the coupler extends from the clamp and includes a rod that threads into the opening of the armature. In a variant of this aspect, the clamp includes a shoulder that engages the adjustment lever plate when the rod is threaded into the opening of the armature such that the clamp is in the locked position to compress the height set plate between the adjustment lever plate and the armature to prevent vertical movement of the height set plate. In another aspect, the coupler extends from the clamp and includes a rod that extends through the opening in the armature, a retainer clip that couples to the rod, and a spring positioned over the rod between the armature and the retainer clip. In a variant of this aspect, the spring is compressed between the armature and the retainer clip to apply a biasing force to the clamp to bias the clamp toward the adjustment lever plate. In another variant, the adjustment lever plate includes a plurality of position openings and the clamp includes a locking arm with a pin extending therefrom, wherein the biasing force of the spring biases the pin into one of the plurality of position openings, thereby locking the clamp into the locked position. In a further variant, the clamp is moveable away from the adjustment lever plate against the biasing force of the spring to withdraw the pin from the one of the plurality of position openings thereby placing the clamp in the unlocked position, and rotatable about a longitudinal axis of the rod to align the pin with another of the position openings. In yet a further variant, when the clamp is rotated to align the pin with the other of the position openings, the clamp may be released to permit the biasing force of the spring to bias the pin into the other of the plurality of position openings, thereby locking the clamp in the locked position. In another variant, the plurality of position openings is arranged to form a curved sequence of position openings, each position opening corresponding to a different cooking gap. In another aspect of this embodiment, the cam slot of the adjustment lever plate is curved between a first end and a second end. In another aspect, the cam body of the adjustment lever plate includes a plurality of position markers positioned along the cam slot, the position markers corresponding to a plurality of cooking gaps when the upper platen assembly is in the lowered position.

According to yet another embodiment, the present disclosure provides a method of setting a desired cooking gap between an upper platen assembly and a lower platen of a griddle, the method comprising: moving a clamp of a locking mechanism to an unlocked position wherein an adjustment lever plate of a height adjustment mechanism is free to rotate about a coupler of the locking mechanism that extends through an opening of the adjustment lever plate, through a slot in a height set plate disposed between the adjustment lever plate, and into an opening of an armature of the upper platen assembly; rotating the adjustment lever plate about the coupler such that a stud extending from the height set plate moves within a cam slot of the adjustment lever plate, thereby adjusting a vertical position of the height set plate relative to the armature to a position corresponding to the desired cooking gap when a lower end of the height set plate engages a stop surface of the lower platen when the upper platen assembly is in a lowered position; and moving the clamp of the locking mechanism to a locked position wherein the clamp prevents rotation of the adjustment lever plate and retains the stud in position within the cam slot, thereby locking the height set plate in position and setting the desired cooking gap.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a side view of a griddle having a lower platen and one upper platen assembly in a raised position and another upper platen assembly in a lowered position

FIG. 2 is a perspective view of one embodiment of a height adjustment mechanism according to the present disclosure coupled to an upper platen assembly;

FIG. 3 is a front view of the height adjustment mechanism of FIG. 2 coupled to an upper platen assembly and set to provide a minimum cooking gap;

FIG. 4 is a front view of the height adjustment mechanism of FIG. 2 coupled to an upper platen assembly and set to provide a maximum cooking gap;

FIGS. 5 and 6 are exploded perspective views of the height adjustment mechanism of FIG. 2;

FIG. 7 is a front view of another embodiment of a height adjustment mechanism according to the present disclosure coupled to an upper platen assembly and set to provide a minimum cooking gap;

FIG. 8 is a front view of the height adjustment mechanism of FIG. 7 coupled to an upper platen assembly and set to provide an intermediate cooking gap;

FIG. 9 is a front view of the height adjustment mechanism of FIG. 7 coupled to an upper platen assembly and set to provide a maximum cooking gap;

FIG. 10 is an exploded perspective view of the height adjustment mechanism of FIG. 7;

FIG. 11 is a perspective view of another embodiment of a height adjustment mechanism according to the present disclosure coupled to an upper platen assembly and set to provide a minimum cooking gap;

FIG. 12 is a perspective view of the height adjustment mechanism of FIG. 11 coupled to an upper platen assembly and set to provide a maximum cooking gap;

FIG. 13 is an exploded perspective view of the height adjustment mechanism of FIG. 11;

FIG. 14 is a perspective view of the height adjustment mechanism of FIG. 11 with a height locking mechanism in a locked position; and

FIG. 15 is a perspective view of the height adjustment mechanism of FIG. 11 with the height locking mechanism in an unlocked position.

Corresponding reference characters indicate corresponding parts throughout the several views. The exemplification set out herein illustrates an embodiment of the invention, the embodiment disclosed below is not intended to be exhaustive or to be construed as limiting the scope of the invention in any manner.

### DETAILED DESCRIPTION

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrative devices and described methods and further applications of the principles of the invention which would normally occur to one skilled in the art to which the invention relates.

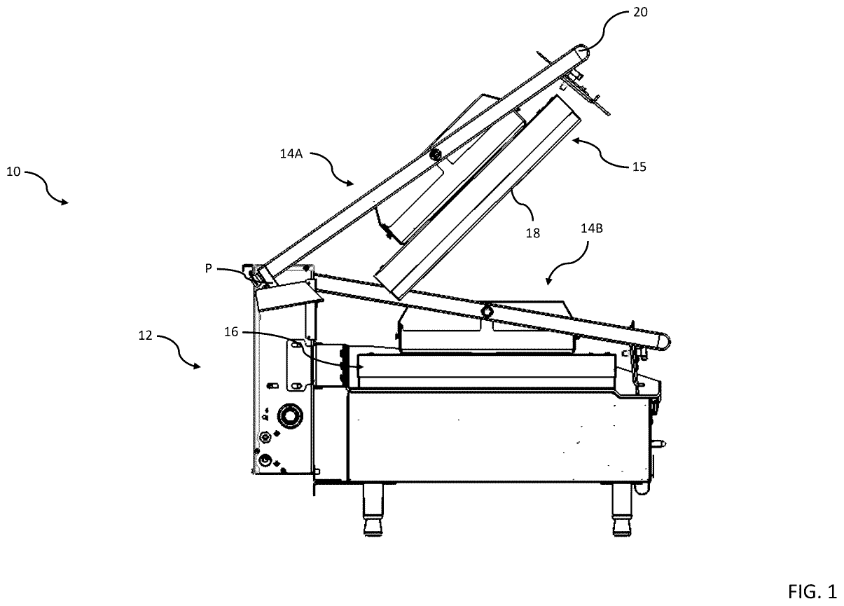

FIG. 1 depicts a griddle assembly 10 according to one embodiment of the present disclosure. The griddle assembly 10 generally includes a griddle 12 and an upper platen assembly 14. In the example depicted, two upper platen assemblies 14A, 14B are connected to the griddle 12. The griddle 12 presents a cooking surface in the form of a lower platen 16 facing upward toward the upper platen assembly 14. The upper platen assembly 14 includes an upper platen 15 that presents a food engaging surface in the form of the lower surface 18 of the upper platen 15 facing downward toward the griddle 12. In the embodiment illustrated, the upper platen assembly 14 includes a heater (not shown) for heating the lower surface 18 for active cooking. In alternative configurations, the lower surface 18 may not be heated. The lower surface 18 of the upper platen 15 may, e.g., be used to compress food items for cooking with or without the lower surface 18 being heated.

In the open position of upper platen assembly 14A, a food item can be placed on the lower platen 16 such that the upper platen assembly 14A can be rotated about pivot axis P from the open position to the closed position as shown by upper platen assembly 14B depicted in FIG. 1. When in the closed position, the lower surface 18 of the upper platen 15 is placed atop the food item for cooking the food item. The lower platen 16 is a heated cooking surface in the exemplification described herein. From the closed position illustrated in FIG. 1, the upper platen assembly 14B can be rotated about the pivot axis P to the open position, allowing unloading/loading of food items positioned on the lower platen 16. The upper platen assembly 14A, 14B can be rotated, e.g., through an arc of up to 90° between its open and closed positions. Alternative upper platen assemblies 14 may be rotated through an arc about the pivot axis of, for example, 30°, 35°, 45°, 50°, 55°, 60°, 65°, 70°, 75°, 80°, 85°, or 90° when positioning the upper platen assembly 14A, 14B between the closed position to the open position and vice versa.

To rotate the upper platen assembly 14 between the closed position and the open position, a force is applied by an operator to a handle 20 to rotate the upper platen assembly 14 about the pivot axis P. A counterbalance such as the one disclosed in co-pending U.S. patent application Ser. No. 17/696,759, filed Mar. 16, 2022 and entitled COUNTERBALANCE FOR UPPER GRIDDLE PLATEN, the entire disclosure of which is hereby explicitly incorporated herein by reference, may be implemented to reduce the force on the handle 20 needed to articulate the upper platen assembly 14 between the closed position and the open position. Additionally, the upper platen 15 may be a self-leveling platen such as one of the self-leveling upper platens disclosed in U.S. Pat. No. 11,819,160, filed May 13, 2019 and entitled MODULAR GRIDDLE WITH SEARING DEVICE, the entire disclosure of which is hereby explicitly incorporated herein by reference.

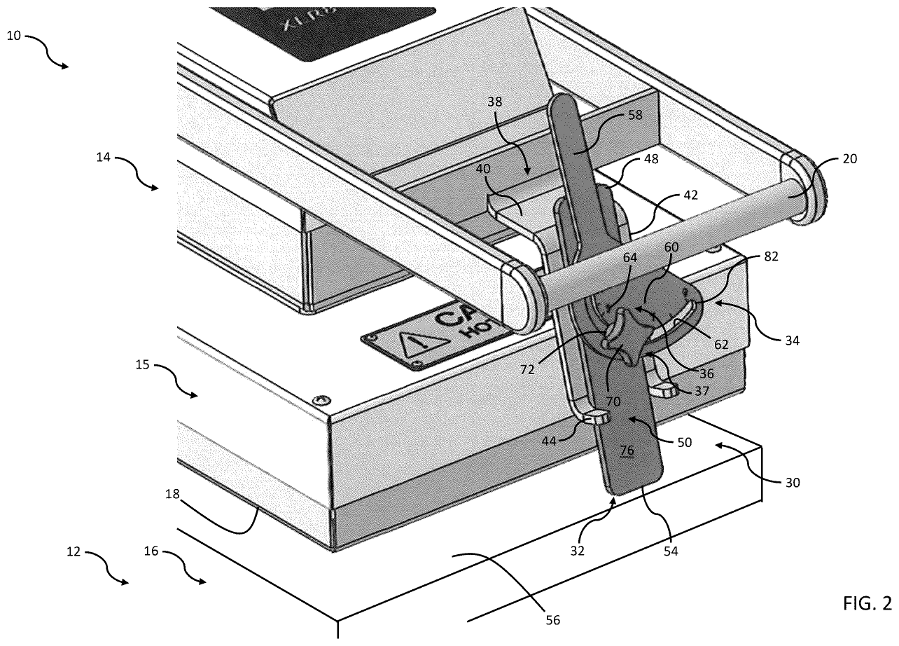

Referring now to FIG. 2, an exemplary embodiment of a height adjustment mechanism 30 according to the present disclosure is shown. The height adjustment mechanism 30 generally includes a height set plate 32, an adjustment lever plate 34 and a locking mechanism 36. In certain embodiments, the height set plate 32 is coupled to an armature 38 of the upper platen assembly 14. The armature 38 has an extension segment 40 that supports a downwardly extending support segment 42. The support segment 42 includes a pair of outwardly directed guide arms 44.

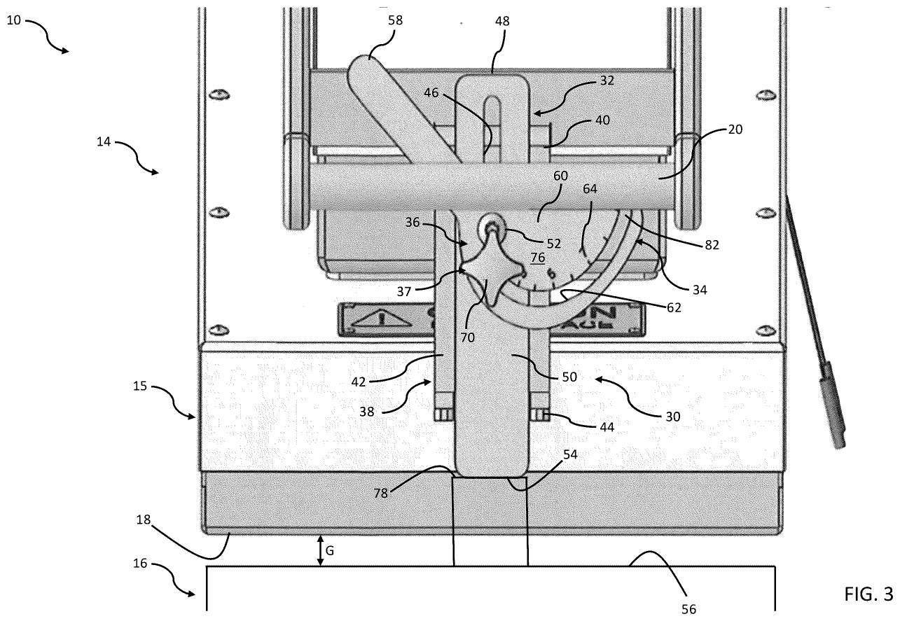

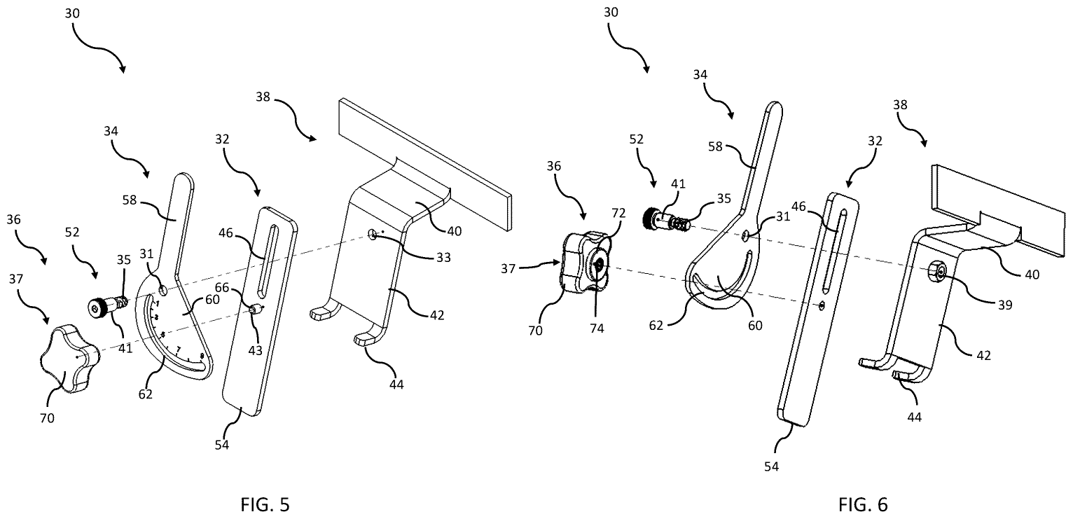

As best shown in FIG. 3, the height set plate 32 includes a longitudinal slot 46 extending along a longitudinal axis of the height set plate 32 between a position adjacent an upper end 48 of the height set plate 32 and a position adjacent a central portion 50 of the height set plate 32. The length of the slot 46 determines the range of adjustment of the height set plate 32 as is further described below. The height set plate 32 is coupled to the support segment 42 of the armature 38 by a coupler 52 of the locking mechanism 36. In certain embodiments, the coupler 52 extends through an opening 31 (FIGS. 5 and 6) of the adjustment lever plate 34, through the slot 46 of the height set plate 32 and into an opening 33 (FIG. 5) formed in the support segment 42. In certain embodiments, the coupler 52 is a bolt with a threaded end 35 that is threaded into the opening 33 formed in the support segment 42. In the depicted embodiment, a welded nut 39 is attached to a rearward surface of the support segment 42 to receive the threaded end 35 of the coupler 52. Alternatively, instead of a threaded opening in the support segment 42 to receive the coupler 52, a nut may be welded to the support segment 42 to receive the coupler 52.

The coupler 52 performs a plurality of functions. The coupler 52 couples the adjustment lever plate 34 and the height set plate 32 to the support segment 42 of the armature 38. The coupler 52 also provides a pivot point for rotation of the adjustment lever plate 34 as is further described below. Finally, by being positioned within the slot 46 of the height set plate 32, an unthreaded portion 41 of the coupler 52 guides vertical movement of the height set plate 32 as the height set plate 32 is adjusted in the manner described below. It should be understood, however, that a variety of different mechanisms may be used instead of the depicted coupler 52 to perform these functions. For example, a bolt may extend from the support segment 42 through the slot 46 and the opening 31 in the adjustment lever plate 34 and receive a nut or combination of a washer and a nut. Alternatively, the coupler 52 may be replaced with a rivet or other structure.

As indicated above, the coupler 52 is coupled to the support segment 42 in a manner that permits vertical sliding movement of the height set plate 32 along the extent of the slot 46 as is further described below. The vertical sliding movement of the height set plate 32 is guided by the coupler 52 within the slot 46 and the guide arms 44 of the support segment 42 of the armature 38. As is further described below, the position of a lower end 54 of the height set plate 32 relative to the support segment 42 of the armature 38 sets a gap between the lower surface 18 of the upper platen 15 and an upper surface 56 of the lower platen 16. Hereinafter, this gap is referred to as “the cooking gap G.”

Still referring to FIGS. 2, 3, 5 and 6, the adjustment lever plate 34 includes a lever 58 and a cam body 60. The cam body 60 includes a curved slot 62 and, in certain embodiments, a plurality of position markers 64 are located along the curved slot 62 and correspond to a plurality of different cooking gaps G. In certain embodiments, the curved slot 62 is a spiral curve. In alternative embodiments, the curved slot 62 is a circular arc, a parabolic arc, an nth-polynomial arc, a hyperbolic arc, an elliptical arc, a cubic spline or some other suitable curved shape. In further alternative embodiments, the slot 62 is not curved, and extends substantially along a straight line.

A stud 66 extends from the height set plate 32 through the curved slot 62. In an exemplary embodiment, the stud 66 includes a threaded end 43. In this embodiment, the locking mechanism 36 also includes a clamp 37 which includes an outer grasping portion 70, a shoulder 72, and a threaded opening 74 formed into the shoulder 72. The clamp 37 functions to secure the adjustment lever plate 34 and the height set plate 32 in a particular position relative to the support segment 42 of the armature 38. More specifically, the threaded opening 74 of the clamp 37 is threaded onto the threaded end 43 of the stud 66 positioned within the curved slot 62 of the adjustment lever plate 34. When the threaded opening 74 is threaded sufficiently onto the threaded end 43, the shoulder 72 of the clamp 37 engages an outer surface 76 of the cam body 60 of the adjustment lever plate 34 and compresses the adjustment lever plate 34 against the height set plate 32. The compression in turn compresses the height set plate 32 against the support segment 42 of the armature 38, thereby locking the adjustment lever plate 34 and the height set plate 32 in a selected position.

While the clamp 37 is described herein as including a threaded opening 74 that is threaded onto a threaded end 43 of the stud 66, it should be understood that, alternatively, the stud 66 may have a threaded opening with internal threads (not a threaded end) and the threaded opening 74 of the clamp 37 may be replaced with a threaded rod with external threads that are received by the threaded opening of the stud 66. Alternatively, the stud 66 may be omitted entirely and replaced with a threaded opening on the height set plate 32 that receives a threaded rod. In such an embodiment, the threaded rod would include an unthreaded portion that functions as the stud 66 as it is positioned within the curved slot 62 of the adjustment lever plate 34.

When the adjustment lever plate 34 and the height set plate 32 are locked in a selected position, such as the position shown in FIG. 3, the lower end 54 of the height set plate 32 engages a stop surface 78 of the lower platen 16 and sets the cooking gap G between the lower surface 18 of the upper platen assembly 14 and the upper surface 56 of the lower platen 16. As should be apparent from the foregoing, the position of the height set plate 32 relative to the armature 38 determines the extent to which the lower end 54 of the height set plate 32 extends below the support segment 42 of the armature 38. The farther the lower end 54 of the height set plate 32 extends below the armature 38, the larger the cooking gap G.

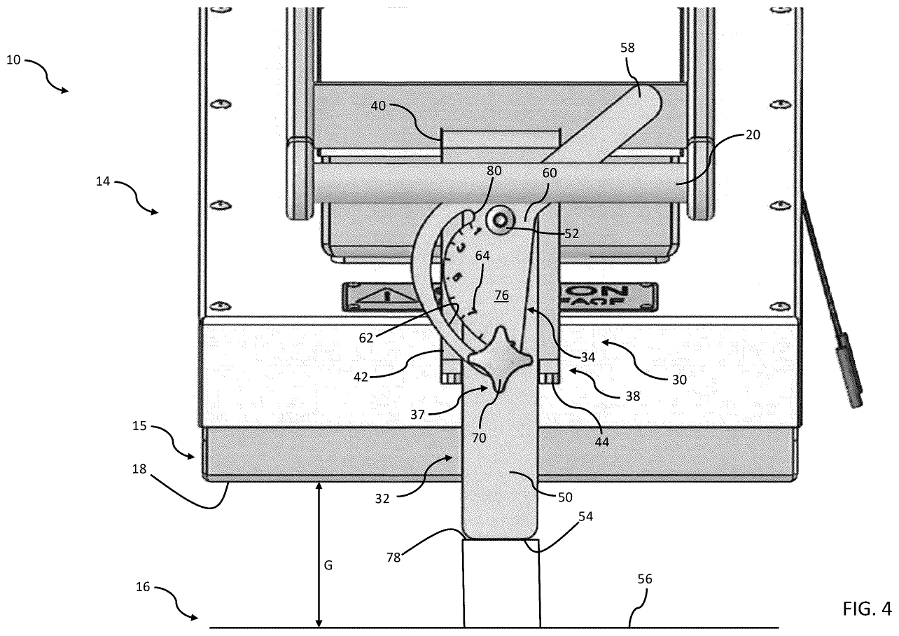

To adjust the cooking gap G, an operator grasps the grasping portion 70 of the clamp 37 and rotates the clamp 37 to partially unthread the threaded opening 74 from the threaded end 43 of the stud 66 of the height set plate 32. This releases or reduces the compression force applied by the shoulder 72 of the clamp 37 to the adjustment lever plate 34 and the height set plate 32. After the compression force is released (or at least reduced), the operator may grasp the lever 58 of the adjustment lever plate 34 to rotate the adjustment lever plate 34 about the coupler 52. As the adjustment lever plate 34 rotates about the coupler 52, the stud 66 of the height set plate 32 moves within the curved slot 62 of the cam body 60 of the adjustment lever plate 34. In the position shown in FIG. 3, the stud 66 is positioned adjacent a first end 80 (FIG. 4) of the curved slot 62, which corresponds to the height set plate 32 being positioned at its maximum upper position, which corresponds to a minimum cooking gap G.

Referring now to FIG. 4, the adjustment lever plate 34 is shown rotated in a clockwise direction such that the stud 66 of the height set plate 32 is positioned adjacent a second end 82 (FIG. 3) of the curved slot 62, which corresponds to the height set plate 32 being positioned at its maximum lower position, which corresponds to a maximum cooking gap G. As should be apparent from the foregoing, the position of the height set plate 32 (and therefore the position of the lower end 54) may be adjusted by rotating the adjustment lever plate 34 about the coupler 52 to any position between the position shown in FIG. 3 and the position shown in FIG. 4. In this manner, the position of the lower end 54 of the height set plate 32, and therefore the size of the cooking gap G, may be adjusted to any of an infinite number of positions.

The operator may use the position markers 64 as an aid to select a position of the stud 66 in the curved slot 62 that corresponds to a desired cooking gap G. In certain embodiments, the position markers 64 are located along an edge of the height adjustment plate 32 and an indicator is provided on the support segment 42 of the armature 38 adjacent the edge of the height adjustment plate 32. In such an embodiment, the height set plate 32 may be moved such that a desired position marker 64 aligns with the indicator thereby resulting in a desired cooking gap G. In other embodiment, the position markers 64 may be omitted entirely.

After the operator uses the lever 58 to rotate the adjustment lever plate 34 to set the position of the lower end 54 of the height set plate 32 (and therefore, the cooking gap G), the operator rotates the clamp 37 to thread the threaded opening 74 onto the threaded end 43 of the stud 66 until the shoulder 72 of the clamp 37 applies a compression force to the adjustment lever plate 34 and the height set plate 32, which compresses the height set plate 32 against the support segment 42 of the armature 38 to lock the height set plate 32 into the desired position.

Therefore, the cooking gap G may be adjusted to and locked at any thickness within the range of thicknesses corresponding to the range of vertical positions of the height set plate 32, all without the use of any tools. It should be understood, however, that in alternative embodiments the clamp 37 may be replaced with a bolt and nut connection, for example, that requires the use of a screwdriver and/or wrench to loosen and/or tighten the connection.

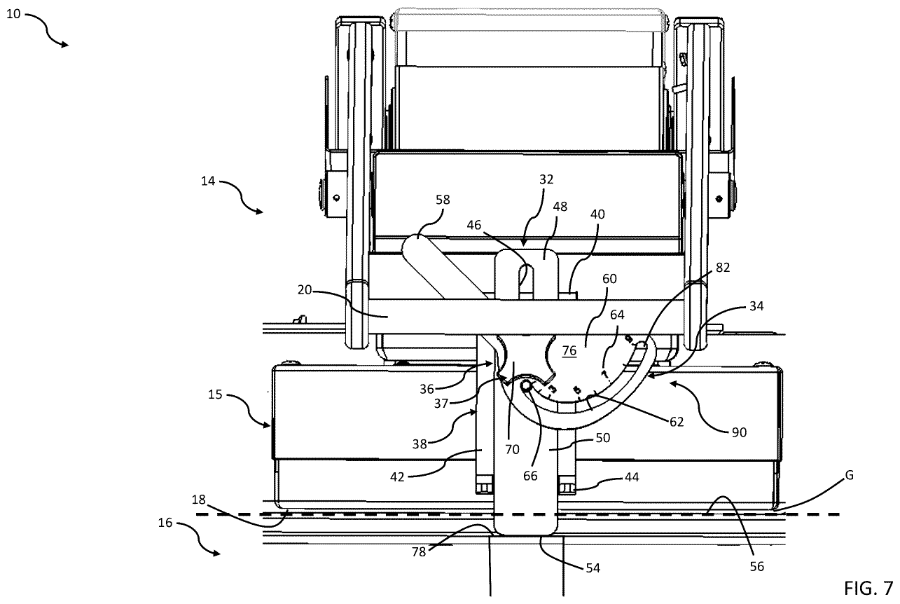

FIGS. 7-10 depict an alternative embodiment of a height adjustment mechanism according to the present disclosure. The height adjustment mechanism 90 of these figures is similar to the height adjustment mechanism 30 discussed above. Accordingly, a description of the common features will not be repeated in the description of height adjustment mechanism 90 that follows. Instead of including a separate coupler 52 as the pivot point for the adjustment lever plate 34 (and a guide for the height set plate 32), the locking mechanism 36 includes a coupler 52 that extends from the clamp 37 of the height adjustment mechanism 90 and the combination of the clamp 37 and the coupler 52 are used to provide the pivot point, to guide the height set plate 32 and to lock the adjustment lever plate 34 and the height set plate 32 in a desired position. Additionally, the stud 66 extending from the height set plate 32 does not have a threaded end, and simply functions to move within the curved slot 62 of the adjustment lever plate 34.

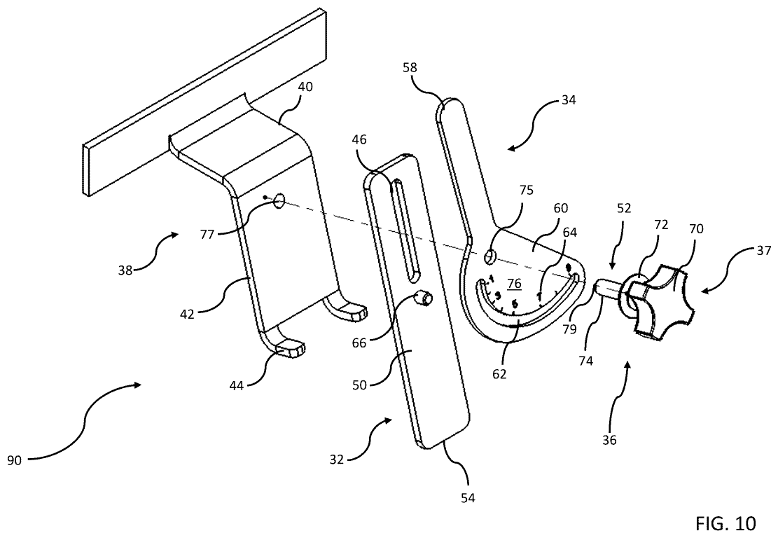

More specifically, as best shown in FIG. 10, the coupler 52 includes a rod 74 with a threaded end 79 that extends from the clamp 37 through an opening 75 in the adjustment lever plate 34, the slot 46 of the height set plate 32, and into a threaded opening 77 in the support segment 42 of the armature 38. It should be understood, however, that in alternative embodiments the connection between the locking mechanism 36 and the support segment 42 may be accomplished in a variety of ways such as those described above with reference to the coupler 52. When the clamp 37 is not tightly threaded into the threaded opening 77 in the support segment 42, the adjustment lever plate 34 is free to rotate about the rod 74, thereby causing the stud 66 to move within the curved slot 62 to adjust the position of the height set plate 32 relative to the armature 38 as described above. When a desired position for the height set plate 32 is selected, the operator tightens the clamp 27 which causes the shoulder 72 of the clamp 37 to apply a compression force to the adjustment lever plate 34 and the height set plate 32, thereby locking both parts in position relative to the support segment 42 of the armature 38.

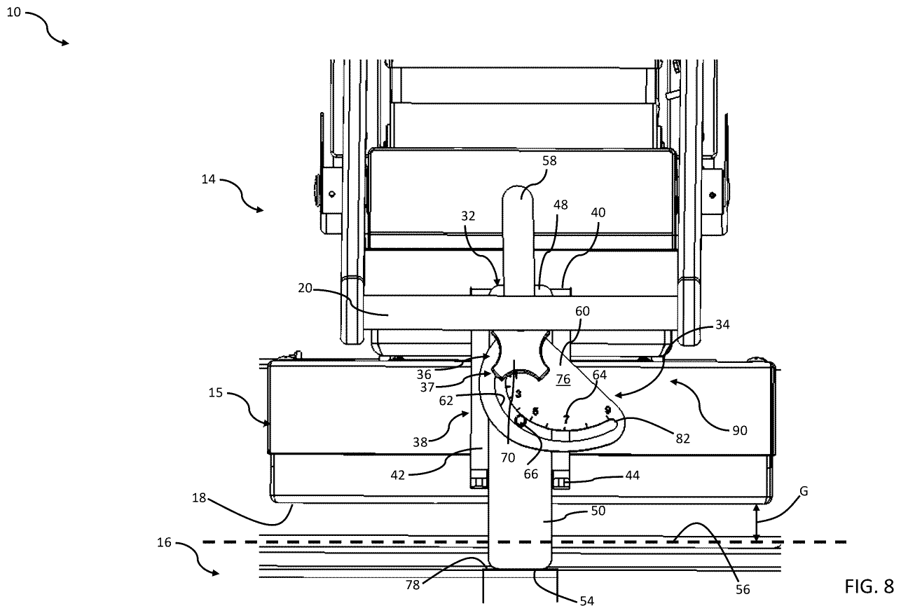

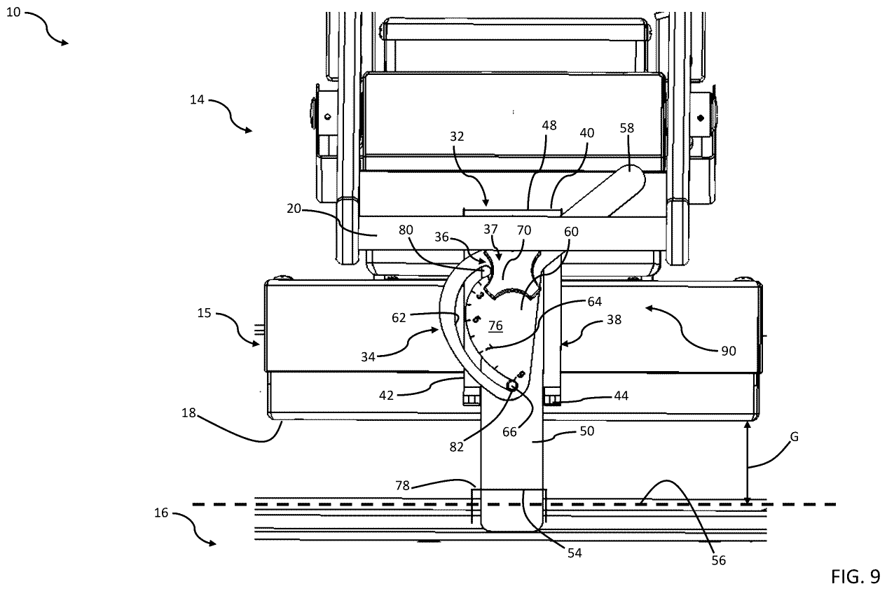

In FIG. 7, the height set plate 32 is shown at its uppermost position, which corresponds to a minimum cooking gap G. In this position, the stud 66 of the height set plate 32 is positioned adjacent the first end 80 (FIG. 9) of the slot 62 of the adjustment lever plate 34. In FIG. 8, the height set plate 32 is shown at an intermediate position, which corresponds to a cooking gap G that is larger than the minimum cooking gap G. In this position, the stud 66 of the height set plate 32 is positioned in an intermediate position of the slot 62 of the adjustment lever plate 34. In FIG. 9, the height set plate 32 is shown at its lowermost position, which corresponds to a maximum cooking gap G. In this position, the stud 66 of the height set plate 32 is positioned adjacent the second end 82 of the slot 62 of the adjustment lever plate 34.

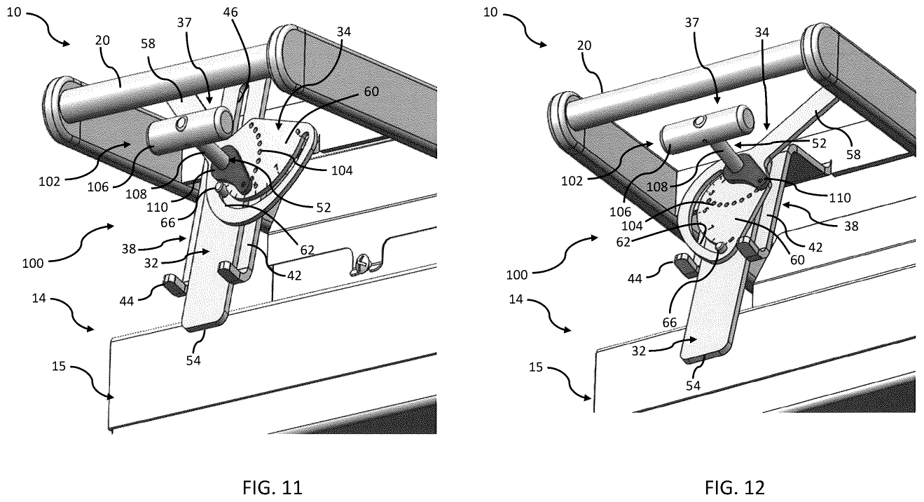

Referring now to FIGS. 11-15, yet another embodiment of a height adjustment mechanism is shown. The height adjustment mechanism 100 of these figures is similar to the height adjustment mechanism 30 discussed above. Accordingly, the description of the common features will not be repeated in the description of height adjustment mechanism 100 that follows. The height adjustment mechanism 100 includes a locking mechanism 102 that functions as the pivot point for the adjustment lever plate 34 and a clamp to lock the height set plate 32 in a desired position.

The height adjustment plate 32 of the height adjustment mechanism 100 is identical to that described above with reference to adjustment mechanism 90. The adjustment lever plate 34, however, includes a plurality of position openings 104 formed in or through the cam body 60. In certain embodiments, the position openings 104 are positioned adjacent one another such that they form a curved sequence of position openings 104 which are used to lock the height set plate 32 in a desired position as described below.

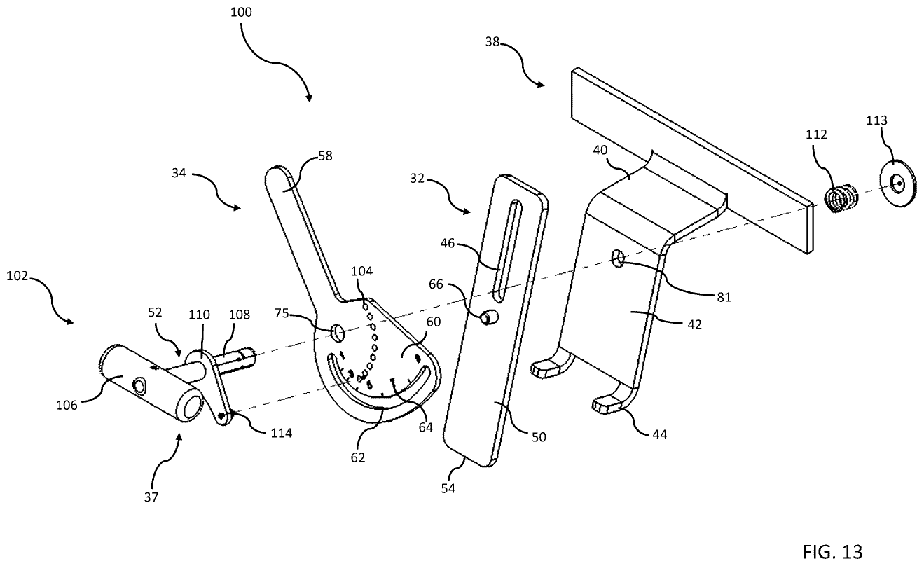

As best shown in FIG. 13, the height locking mechanism 102 includes a clamp 37 having a handle 106, a coupler 52 having a rod 108 extending from the handle 106, and a locking arm 110 coupled to the rod 108. The rod 108 is passed through an opening 75 of the adjustment lever plate 34, the slot 46 of the height adjustment plate 32, and an unthreaded opening 81 of the support member 42 of the armature 38. A spring 112 is placed over the end of the rod 108 and a retainer clip 113 is coupled to the end of the rod 108. In this manner, the spring 112 is compressed between the retainer clip 113 and the rearward surface of the support member 42 of the armature 38, thereby applying a biasing force to the height locking mechanism 102 drawing it toward the adjustment lever plate 32. An inwardly directed pin 114 extends from an inner surface of an end of the locking arm 110 and in operation registers with one of the position openings 104 as described below.

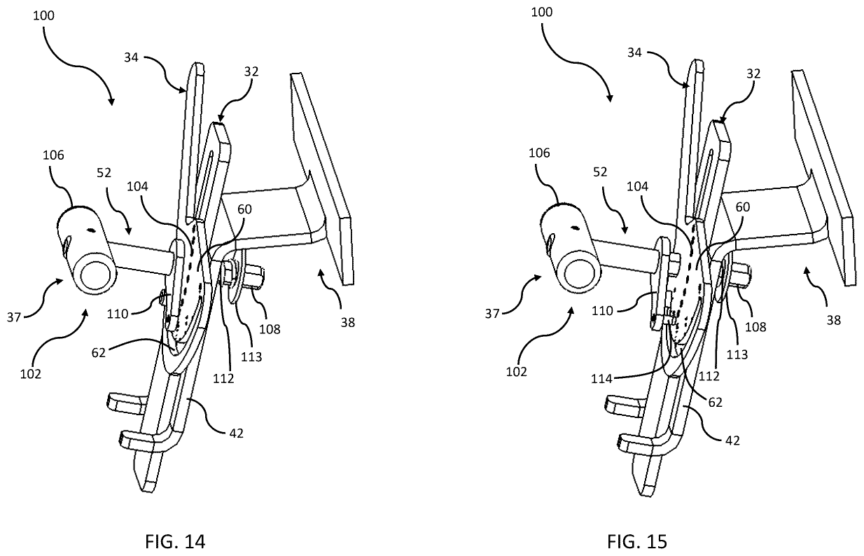

As best shown in FIGS. 14 and 15, to adjust the height of the height set plate 32 (and therefore the cooking gap G), the operator grasps the handle 106 of the clamp 37 of the height locking mechanism 102 and pulls outwardly against the biasing force of the spring 112, thereby moving the locking arm 110 outwardly and withdrawing the pin 114 from a position opening 104. In this state the height locking mechanism 102 is in an unlocked position as depicted in FIG. 15. The operator then rotates the adjustment lever plate 34 in the manner described above to select a desired height of the height set plate 32. When a desired height is selected, the operator releases the height locking mechanism 102 to permit the pin 114 to enter a position opening 104, where it is retained by the biasing force of the spring 112. In this state the height locking mechanism 102 is in a locked position as depicted in FIG. 14. When in the locked position, the engagement between the pin 114 and the selected position opening 104 prevents the adjustment lever plate 34 from rotating, which maintains the stud 66 of the height set plate 32 in position within the slot 62 of the adjustment lever plate 34. This, in turn, prevents the height set plate 32 from moving upwardly or downwardly relative to the armature 38, thereby setting a desired cooking gap G.

FIG. 11 shows the height locking mechanism 102 locking the height set plate 32 in its uppermost position, wherein the pin 114 of the locking arm 110 is positioned in a position opening 104 at one end of the sequence of position openings 104. FIG. 12 shows the height locking mechanism 102 locking the height set plate 32 in its lowermost position, wherein the pin 114 of the locking arm 110 is positioned in a position opening 104 at another end of the sequence of position openings 104. The use of the pin 114 and the position openings 104, while providing a finite number of positions for the height set plate 32 (and therefore a finite number of cooking gap G thicknesses), prevents any slippage of the position of the height set plate 32 as a result, for example, of significant changes in acceleration of the upper platen 15, such as when it is caused to quickly engage the stop surface 78. In certain embodiments, the spacing of the position openings 104 may correspond to cooking gap G thickness increments of, for example, ¼ inch. It should be understood, however, that the spacing of the position openings 104 and the curvature of the sequence of position openings 104 may be adjusted to provide other cooking gap G thickness increments, which may be non-linear depending upon the curvature of the series of position openings 104.

Any directional references used with respect to any of the figures, such as right or left, up or down, or top or bottom, are intended for convenience of description, and do not limit the present disclosure or any of its components to any particular positional or spatial orientation. Additionally, any reference to rotation in a clockwise direction or a counter-clockwise direction is simply illustrative. Any such rotation may be implemented in the reverse direction as that described herein.

Although the foregoing text sets forth a detailed description of embodiments of the disclosure, it should be understood that the legal scope of the invention is defined by the words of the claims set forth at the end of this patent and equivalents. The detailed description is to be construed as exemplary only and does not describe every possible embodiment. Numerous alternative embodiments may be implemented, using either current technology or technology developed after the filing date of this patent, which would still fall within the scope of the claims.

The following additional considerations apply to the foregoing description. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A height adjustment mechanism for setting a cooking gap between an upper platen assembly and a lower platen of a griddle assembly when the upper platen assembly is in a lowered position, comprising:
a height set plate configured to be coupled to an armature of the upper platen assembly for vertical movement, the height set plate including a slot, a stud and a lower end configured to engage a stop surface of the lower platen when the upper platen assembly is in the lowered position;
an adjustment lever plate coupled to the armature for rotatable movement relative to the height set plate, the adjustment lever plate including a cam body having a cam slot configured to receive the stud of the height set plate, and an opening extending through the cam body; and
a locking mechanism comprising:
a coupler extending through the opening of the cam body, through the slot of the height set plate, and into an opening of the armature, and
a clamp that is movable between an unlocked position wherein the cam body may be rotated about the coupler to cause the stud to move within the cam slot, thereby adjusting a vertical position of the height set plate relative to armature to a vertical position corresponding to a desired cooking gap when the lower end of the height set plate engages the stop surface of the lower platen when the upper platen assembly is in the lowered position, and a locked position wherein the clamp prevents rotation of the cam body and retains the stud in position within the cam slot, thereby locking the height set plate in position and setting the desired cooking gap.

2. The height adjustment mechanism of claim 1, wherein the coupler is a fastener that couples the adjustment lever plate and the height set plate to the armature and permits the adjustment of the vertical position of the height set plate and rotational movement of the adjustment lever plate relative to the armature.

3. The height adjustment mechanism of claim 2, wherein the clamp includes a rod that threads into the stud of the height set plate.

4. The height adjustment mechanism of claim 3, wherein the clamp includes a shoulder that engages the adjustment lever plate when the rod is threaded into the stud such that the clamp is in the locked position to compress the height set plate between the adjustment lever plate and the armature to prevent vertical movement of the height set plate.

5. The height adjustment mechanism of claim 1, wherein the coupler extends from the clamp.

6. The height adjustment mechanism of claim 5, wherein the coupler includes a rod that threads into the opening of the armature.

7. The height adjustment mechanism of claim 6, wherein the clamp includes a shoulder that engages the adjustment lever plate when the rod is threaded into the opening of the armature such that the clamp is in the locked position to compress the height set plate between the adjustment lever plate and the armature to prevent vertical movement of the height set plate.

8. The height adjustment mechanism of claim 5, wherein the coupler includes a rod that extends through the opening in the armature, a retainer clip that couples to the rod, and a spring positioned over the rod between the armature and the retainer clip.

9. The height adjustment mechanism of claim 8, wherein the spring is compressed between the armature and the retainer clip to apply a biasing force to the clamp to bias the clamp toward the adjustment lever plate.

10. The height adjustment mechanism of claim 9, wherein the adjustment lever plate includes a plurality of position openings and the clamp includes a locking arm with a pin extending therefrom, wherein the biasing force of the spring biases the pin into one of the plurality of position openings, thereby locking the clamp into the locked position.

11. The height adjustment mechanism of claim 10, wherein the clamp is moveable away from the adjustment lever plate against the biasing force of the spring to withdraw the pin from the one of the plurality of position openings thereby placing the clamp in the unlocked position, and rotatable about a longitudinal axis of the rod to align the pin with another of the position openings.

12. The height adjustment mechanism of claim 11, wherein when the clamp is rotated to align the pin with the other of the position openings, the clamp may be released to permit the biasing force of the spring to bias the pin into the other of the plurality of position openings, thereby locking the clamp in the locked position.

13. The height adjustment mechanism of claim 10, wherein the plurality of position openings is arranged to form a curved sequence of position openings, each position opening corresponding to a different cooking gap.

14. The height adjustment mechanism of claim 8, wherein the clamp includes a handle for moving the clamp away from the adjustment lever plate and rotating the clamp relative to the adjustment lever plate.

15. The height adjustment mechanism of claim 1, wherein the height set plate is guided through vertical movement relative to the armature by a pair of guide arms extending from the armature.

16. The height adjustment mechanism of claim 1, wherein the slot of the height set plate extends along a longitudinal axis of the height set plate.

17. The height adjustment mechanism of claim 1, wherein the adjustment lever plate includes a lever extending from the cam body for rotating the adjustment lever plate relative to the height adjustment plate.

18. The height adjustment mechanism of claim 1, wherein the cam slot of the adjustment lever plate is curved between a first end and a second end.

19. The height adjustment mechanism of claim 1, wherein the cam body of the adjustment lever plate includes a plurality of position markers positioned along the cam slot, the position markers corresponding to a plurality of cooking gaps when the upper platen assembly is in the lowered position.

20. An upper platen assembly for a griddle, comprising:
an upper platen having a lower surface;
an armature extending from the upper platen;
a handle for moving the upper platen assembly between a raised position and a lowered position wherein the lower surface of the upper platen is spaced apart from an upper surface of a lower platen of the griddle by a cooking gap; and
a height adjustment mechanism coupled to the armature, the height adjustment mechanism comprising:
a height set plate configured to the armature for vertical movement relative to the armature, the height set plate including a slot, a stud and a lower end configured to engage a stop surface of the lower platen when the upper platen assembly is in the lowered position, thereby setting the cooking gap;
an adjustment lever plate coupled to the armature for rotatable movement relative to the height set plate, the adjustment lever plate including a cam body having a cam slot configured to receive the stud of the height set plate, and an opening extending through the cam body; and
a locking mechanism including a coupler and a clamp;
wherein the coupler extends through the opening of the cam body, through the slot of the height set plate, and into an opening of the armature; and
wherein the clamp is movable between an unlocked position wherein the cam body may be rotated about the coupler to cause the stud to move within the cam slot, thereby adjusting a vertical position of the height set plate relative to armature to a vertical position corresponding to a desired cooking gap when the lower end of the height set plate engages the stop surface of the lower platen when the upper platen assembly is in the lowered position, and a locked position wherein the clamp prevents rotation of the cam body and retains the stud in position within the cam slot, thereby locking the height set plate in position and setting the desired cooking gap.

21. The upper platen assembly of claim 20, wherein the coupler is a fastener that couples the adjustment lever plate and the height set plate to the armature and permits the adjustment of the vertical position of the height set plate and rotational movement of the adjustment lever plate relative to the armature.

22. The upper platen assembly of claim 21, wherein the clamp includes a rod that threads into the stud of the height set plate.

23. The upper platen assembly of claim 22, wherein the clamp includes a shoulder that engages the adjustment lever plate when the rod is threaded into the stud such that the clamp is in the locked position to compress the height set plate between the adjustment lever plate and the armature to prevent vertical movement of the height set plate.

24. The upper platen assembly of claim 20, wherein the coupler extends from the clamp and includes a rod that threads into the opening of the armature.

25. The upper platen assembly of claim 24, wherein the clamp includes a shoulder that engages the adjustment lever plate when the rod is threaded into the opening of the armature such that the clamp is in the locked position to compress the height set plate between the adjustment lever plate and the armature to prevent vertical movement of the height set plate.

26. The upper platen assembly of claim 20, wherein the coupler extends from the clamp and includes a rod that extends through the opening in the armature, a retainer clip that couples to the rod, and a spring positioned over the rod between the armature and the retainer clip.

27. The upper platen assembly of claim 26, wherein the spring is compressed between the armature and the retainer clip to apply a biasing force to the clamp to bias the clamp toward the adjustment lever plate.

28. The upper platen assembly of claim 27, wherein the adjustment lever plate includes a plurality of position openings and the clamp includes a locking arm with a pin extending therefrom, wherein the biasing force of the spring biases the pin into one of the plurality of position openings, thereby locking the clamp into the locked position.

29. The upper platen assembly of claim 28, wherein the clamp is moveable away from the adjustment lever plate against the biasing force of the spring to withdraw the pin from the one of the plurality of position openings thereby placing the clamp in the unlocked position, and rotatable about a longitudinal axis of the rod to align the pin with another of the position openings.

30. The upper platen assembly of claim 29, wherein when the clamp is rotated to align the pin with the other of the position openings, the clamp may be released to permit the biasing force of the spring to bias the pin into the other of the plurality of position openings, thereby locking the clamp in the locked position.

31. The upper platen assembly of claim 28, wherein the plurality of position openings is arranged to form a curved sequence of position openings, each position opening corresponding to a different cooking gap.

32. The upper platen assembly of claim 20, wherein the cam slot of the adjustment lever plate is curved between a first end and a second end.

33. The upper platen assembly of claim 20, wherein the cam body of the adjustment lever plate includes a plurality of position markers positioned along the cam slot, the position markers corresponding to a plurality of cooking gaps when the upper platen assembly is in the lowered position.

34. A method of setting a desired cooking gap between an upper platen assembly and a lower platen of a griddle, the method comprising:
moving a clamp of a locking mechanism to an unlocked position wherein an adjustment lever plate of a height adjustment mechanism is free to rotate about a coupler of the locking mechanism that extends through an opening of the adjustment lever plate, through a slot in a height set plate disposed between the adjustment lever plate, and into an opening of an armature of the upper platen assembly;
rotating the adjustment lever plate about the coupler such that a stud extending from the height set plate moves within a cam slot of the adjustment lever plate, thereby adjusting a vertical position of the height set plate relative to the armature to a position corresponding to the desired cooking gap when a lower end of the height set plate engages a stop surface of the lower platen when the upper platen assembly is in a lowered position; and
moving the clamp of the locking mechanism to a locked position wherein the clamp prevents rotation of the adjustment lever plate and retains the stud in position within the cam slot, thereby locking the height set plate in position and setting the desired cooking gap.
